(19) United States
(12) Patent Application Publication
(10) Pub. No.: US 2021/0257656 A1
(43) Pub. Date: Aug. 19, 2021

(54) LITHIUM PHOSPHATE COATING FOR LITHIUM LANTHANUM ZIRCONIUM OXIDE SOLID-STATE ELECTROLYTE POWDERS

(71) Applicant: GM GLOBAL TECHNOLOGY OPERATIONS LLC, Detroit, MI (US)

(72) Inventor: Thomas A. YERSAK, Ferndale, MI (US)

(73) Assignee: GM GLOBAL TECHNOLOGY OPERATIONS LLC, Detroit, MI (US)

(21) Appl. No.: 16/791,158

(22) Filed: Feb. 14, 2020

(51) Int. Cl. H01M 10/0562; H01M 10/0525; H01M 2/16

(52) U.S. Cl. CPC H01M 10/0562; H01M 2004/027; H01M 2/1653; H01M 10/0525

(57) ABSTRACT

An electrochemical cell that cycles lithium ions is provided. The electrochemical cell includes a positive electrode, a negative electrode, a separator disposed between the positive electrode and the negative electrode, and a lithium phosphate (Li₃PO₄)-coated lithium lanthanum zirconium oxide (LLZO) material. The Li₃PO₄-coated LLZO material is a particle having a substantially spherical core comprising the LLZO and a layer comprising the Li₃PO₄ directly coating at least a portion of the substantially spherical core, the substantially spherical core having a diameter of less than or equal to about 100 μm; a nanowire having an elongate core comprising the LLZO and a layer comprising the Li₃PO₄ directly coating at least a portion of the elongate core, the elongate core having a length of less than or equal to about 10 mm and a diameter of less than or equal to about 100 μm; or a combination thereof.

### INTRODUCTION

This section provides background information related to the present disclosure which is not necessarily prior art.

Electrochemical energy storage devices, such as lithium-ion batteries, can be used in a variety of products, including automotive products, such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes, a separator, and an electrolyte. One of the two electrodes serves as a positive electrode or cathode, and the other electrode serves as a negative electrode or anode. Lithium-ion batteries may also include various terminal and packaging materials. Conventional rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include a solid-state electrolyte disposed between solid-state electrodes, the solid-state electrolyte physically separates the electrodes so that a distinct separator is not required.

Solid-state batteries have advantages over batteries that include a separator and a liquid electrolyte. These advantages include a longer shelf life with lower self-discharge, simpler thermal management systems, a reduced need for packaging, and the ability to operate at a higher energy density within a wider temperature window.

Many prototypical solid-state batteries have an oxide-based solid-state electrolyte. One such electrolyte is lithium lanthanum zirconium oxide (LLZO), which has a high room temperature ionic conductivity ranging from 10⁻³-10⁻⁴ S/cm and good chemical stability. However, LLZO reacts with atmospheric water (H₂O) and carbon dioxide (CO₂) to form a surface layer comprising lithium hydroxide (LiOH) and lithium carbonate (Li₂CO₃), which coats LLZO particles. The LiOH and Li₂CO₃coating does not adequately conduct lithium ions and results in a high interfacial impedance. Although Li₂CO₃can be decomposed by sintering at high temperatures of over 1000° C., this method results in an additional loss of lithium due to evaporation at this high temperature and generates surface contaminants. One such surface contaminant is carbon, which is electronically conductive and promotes dendrite formation. Accordingly, new methods of addressing LiOH and Li₂CO₃ layers formed on oxide-based solid-state electrolyte particles are desired.

### SUMMARY

This section provides a general summary of the disclosure, and is not a comprehensive disclosure of its full scope or all of its features.

The present disclosure relates to lithium phosphate (Li₃PO₄) coating for LLZO solid-state electrolyte powers.

In various aspects, the current technology provides an electrochemical cell that cycles lithium ions, the electrochemical cell including a positive electrode including a positive lithium-based electroactive material and one or more polymeric binder materials, a negative electrode including a negative electroactive material, a separator disposed between the positive electrode and the negative electrode, and a Li₃PO₄-coated LLZO material, wherein the Li₃PO₄-coated LLZO material is a particle having a substantially spherical core including the LLZO and a layer including the Li₃PO₄ directly coating at least a portion of the substantially spherical core, the substantially spherical core having a diameter of less than or equal to about 100 μm; a nanowire having an elongate core including the LLZO and a layer including the Li₃PO₄ directly coating at least a portion of the elongate core, the elongate core having a length of less than or equal to about 10 mm and a diameter of less than or equal to about 100 μm; or a combination thereof.

In one aspect, the Li₃PO₄-coated LLZO material is included as one or more of the separator, a coating on the separator, a component of the separator, a solid-state electrolyte particle disposed in the negative electrode, or a solid-state electrolyte particle disposed in the positive electrode.

In one aspect, the separator is a solid-state electrolyte including the Li₃PO₄-coated LLZO material.

In one aspect, the separator is a polymeric separator including the Li₃PO₄-coated LLZO material as a coating disposed on the polymeric separator.

In one aspect, the polymeric separator includes a polymer selected from the group consisting of polyacrylonitrile (PAN), polyvinylidene fluoride (PVDF), polyethylene (PE), polypropylene (PP), polyethylene terephthalate (PET), a polyamide, and combinations thereof.

In one aspect, the separator is a composite material including a polymeric matrix and the Li₃PO₄-coated LLZO material embedded within the polymeric matrix.

In one aspect, at least one of the positive electrode or the negative electrode includes a solid-state electrolyte disposed therein, wherein the solid-state electrolyte includes the Li₃PO₄-coated LLZO material.

In one aspect, the LLZO has a garnet crystal structure.

In one aspect, the LLZO is doped and has the formula Li_{7-3x-y}AlₓLa₃Zr_{2-y}M_{y}O₁₂, where M is Ta, Nb, or a combination thereof, 0≤x≤1, and 0≤y≤1; Li_{6.5}La₃Zr_{1.5}M_{0.5}O₁₂, where M is Nb, Ta, or a combination thereof Li₇₋ₓLa₃Zr₂₋ₓBiₓO₁₂, where 0≤x≤1;Li_{6.2}Ga_{0.3}La_{2.95}Rb_{0.05}Zr₂O₁₂; Li_{6.65}Ga_{0.15}La₃Zr_{1.9}Sc_{0.1}O₁₂; or combinations thereof.

In various other aspects, the current technology also provides a Li₃PO₄-coated LLZO material including a core including the LLZO and a layer including the Li₃PO₄ directly coating at least a portion of the core, wherein the core is either a particle having a diameter of less than or equal to about 100 μm or a nanowire having a length of less than or equal to about 10 mm and a diameter of less than or equal to about 100 μm.

In one aspect, substantially all of a surface of the core is coated with the layer including the Li₃PO₄.

In one aspect, the LLZO has a garnet crystal structure.

In one aspect, the core is the particle.

In one aspect, the core is the nanowire.

In one aspect, the Li₃PO₄-coated LLZO material is incorporated into at least one component of an electrochemical cell that cycles lithium ions, wherein the at least one component of the electrochemical cell is selected from the group consisting of a solid-state electrolyte, a separator, a coating on a separator, a positive electrode, a negative electrode, and combinations thereof.

In yet other aspects, the current technology provides a method of making a component of an electrochemical cell, the method including adding a LLZO material to a phosphoric acid (H₃PO₄) solution to form a suspension, the LLZO material selected from the group consisting of a LLZO particle core having a diameter of less than or equal to about 100 μm, a LLZO nanowire core having a length of less than or equal to about 10 mm and a diameter of less than or equal to about 100 μm, and combinations thereof; incubating the suspension until the suspension is substantially free of generating CO₂ to form a Li₃PO₄-coated LLZO material; and separating the Li₃PO₄-coated LLZO material from the suspension, wherein the Li₃PO₄-coated LLZO material has a layer including the Li₃PO₄ directly coating at least a portion of the LLZO particle core, the LLZO nanowire core, or a combination thereof.

In one aspect, the Li₃PO₄-coated LLZO material is a powder including a plurality of the LLZO particle cores, and the method further includes optionally combining the powder with a sacrificial binder, pressing the powder between a pair of platens, and sintering the pressed powder to remove the sacrificial binder when present and to generate a solid-state electrolyte including the Li₃PO₄-coated LLZO.

In one aspect, the method further includes combining the Li₃PO₄-coated LLZO material with a polymer electrolyte, a surfactant, and a solvent to form a slurry; casting the slurry on a substrate; removing at least a portion of the solvent to form a composite film including the polymer electrolyte and the Li₃PO₄-coated LLZO material; and removing the composite film from the substrate to yield an electrolyte film.

In one aspect, the Li₃PO₄-coated LLZO material is a powder including a plurality of the LLZO particle cores, and the method further includes combining the powder with a binder, a surfactant, and a solvent to form a slurry; casting the slurry onto a surface of a polymeric separator; and drying the slurry to form a film including the Li₃PO₄-coated LLZO on the surface of the polymeric separator.

In one aspect, the method further includes, prior to the adding, casting a slurry including the LLZO material onto a surface of a polymeric separator and drying the slurry to form a film including the LLZO on the surface of the polymeric separator, wherein the adding the LLZO to the H₃PO₄ solution includes adding the polymeric separator having the film including the LLZO to the H₃PO₄ solution.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of a solid-state battery in accordance with various aspects of the current technology.

FIG. 2 is an illustration of a secondary battery with a liquid electrolyte in accordance with various aspects of the current technology.

FIG. 3 is an illustration of an all-solid-state metal battery in accordance with various aspects of the current technology.

FIG. 4A shows a layer comprising LLZO particles including a layer or bilayer of LiOH and/or Li₂CO₃.

FIG. 4B shows a layer comprising Li₃PO₄-coated LLZO in accordance with various aspects of the current technology.

FIG. 4C shows a Li₃PO₄-coated LLZO particle in accordance with various aspects of the current technology.

FIG. 4D shows a Li₃PO₄-coated LLZO nanowire or nanofiber or microwire or microfiber in accordance with various aspects of the current technology.

FIG. 5A shows non-uniform current density of a ceramic layer disposed on a polymeric separator.

FIG. 5B shows uniform current density of Li₃PO₄-coated LLZO particles disposed on a polymeric separator in accordance with various aspects of the current technology.

FIG. 6 is an illustration showing the formation of a component and a second component of an electrochemical cell in accordance with various aspects of the current technology.

FIG. 7A is an illustration of the formation of the second component of FIG. 6, wherein the second component is a solid-state electrolyte comprising Li₃PO₄-coated LLZO in accordance with various aspects of the current technology.

FIG. 7B is an illustration of the formation of the second component of FIG. 6, wherein the second component is a polymeric separator comprising Li₃PO₄-coated LLZO coated thereon in accordance with various aspects of the current technology.

FIG. 7C is an illustration of the formation of the second component of FIG. 6, wherein the second component is a composite polymeric separator having Li₃PO₄-coated LLZO embedded therein in accordance with various aspects of the current technology.

FIG. 7D is an illustration of the formation of the second component of FIG. 6, wherein the second component is an electrode comprising Li₃PO₄-coated LLZO embedded therein in accordance with various aspects of the current technology.

FIG. 8A is an illustration showing a method of replacing of a layer or bilayer comprising LiOH and/or Li₂CO₃on the surface of LLZO particles with a layer comprising Li₃PO₄, wherein the layer or bilayer is disposed on a polymeric separator in accordance with various aspects of the current technology.

FIG. 8B is an illustration showing a method of replacing of a layer or bilayer comprising LiOH and/or Li₂CO₃on the surface of LLZO particles with a layer comprising Li₃PO₄, wherein the layer or bilayer defines a solid-state separator in accordance with various aspects of the current technology.

FIG. 9 is a spectrograph showing results of Raman spectroscopy performed on LLZO standard, Li₃PO₄ standard, and on Li₃PO₄-coated LLZO prepared in accordance with various aspects of the current technology.

FIG. 10 is a spectrograph showing x-ray diffraction of Li₃PO₄-coated LLZO prepared in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology provides methods of removing a layer comprising at least one of LiOH and Li₂CO₃formed on surfaces of LLZO powder or fibers and replacing the layer with a layer comprising Li₃PO₄. The layer comprising Li₃PO₄ conducts lithium ions. As such, the resulting Li₃PO₄-coated LLZO is suitable for components of electrochemical cells, such as electrolyte particles that can be used in a solid-state electrolyte, in a coating for a polymeric separator, and as solid-state electrolyte particles in cathodes and anodes, as non-limiting examples.

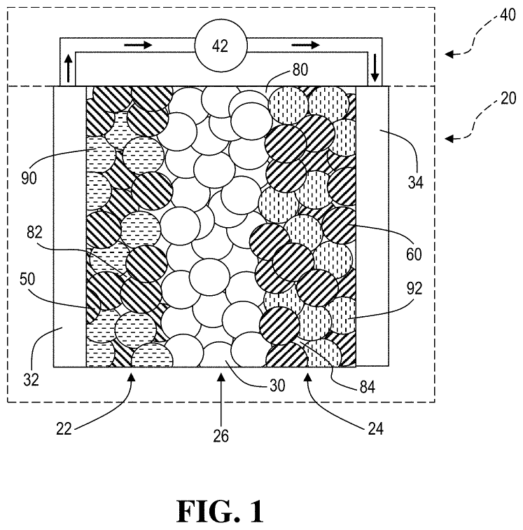

An exemplary and schematic illustration of an all-solid-state electrochemical cell 20 (also referred to herein as “the battery”), i.e., a lithium-ion cell, that cycles lithium ions is shown in FIG. 1. Unless specifically indicated otherwise, the term “ions” as used herein refers to lithium ions. The battery 20 includes a negative electrode 22 (i.e., an anode), a positive electrode 24 (i.e., a cathode), and a solid-state electrolyte 26 disposed between the electrodes 22, 24. The solid-state electrolyte 26 is both a separator that physically separates the negative electrode 22 from the positive electrode 24 and an ion-conducting electrolyte. The solid-state electrolyte 26 may be defined by a first plurality of solid-state electrolyte particles 30. A second plurality of solid-state electrolyte particles or a first liquid electrolyte (i.e., an anolyte) 90 and/or a third plurality of solid-state electrolyte particles or a second liquid electrolyte (i.e., a catholyte) 92 may also be mixed with negative solid-state electroactive particles 50 and positive solid-state electroactive particles 60 present in the negative electrode 22 and the positive electrode 24, respectively, to form a continuous electrolyte network, which may be a continuous solid-state electrolyte network or a solid-liquid hybrid electrolyte network. For example, the negative solid-state electroactive particles 50 and the positive solid-state electroactive particles 60 are independently mixed with no electrolyte, with the second/third plurality of solid-state electrolyte particles 90, 92, or with the first/second liquid electrolyte 90, 92.

A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34). Composite electrodes can also include an electrically conductive diluent, such as carbon black or carbon nanotubes, that is dispersed throughout materials that define the negative electrode 22 and/or the positive electrode 24.

The battery 20 can generate an electric current (indicated by the block arrows) during discharge by way of reversible electrochemical reactions that occur when the external circuit 40 is closed (to connect the negative electrode 22 and the positive electrode 24) and when the negative electrode 22 contains a relatively greater quantity of lithium. The chemical potential difference between the negative electrode 22 and the positive electrode 24 drives electrons produced by the oxidation of inserted lithium at the negative electrode 22 through the external circuit 40 towards the positive electrode 24. Ions, which are also produced at the negative electrode 22, are concurrently transferred through the solid-state electrolyte 26 towards the positive electrode 24. The electrons flow through the external circuit 40, and the ions migrate across the solid-state electrolyte 26 to the positive electrode 24, where they may be plated, reacted, or intercalated. The electric current passing through the external circuit 40 can be harnessed and directed through the load device 42 (in the direction of the block arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The connection of the external power source to the battery 20 compels the non-spontaneous oxidation of one or more metal elements at the positive electrode 24 to produce electrons and ions. The electrons, which flow back towards the negative electrode 22 through the external circuit 40, and the ions, which move across the solid-state electrolyte 26 back towards the negative electrode 22, reunite at the negative electrode 22 and replenish it with lithium for consumption during the next battery discharge cycle. As such, each discharge and charge event is considered to be a cycle, where ions are cycled between the positive electrode 24 and the negative electrode 22.

The external power source that may be used to charge the battery 20 may vary depending on size, construction, and particular end-use of the battery 20. Some notable and exemplary external power sources include, but are not limited to, AC power sources, such as AC wall outlets and motor vehicle alternators, which may require an AC:DC converter. In many of the configurations of the battery 20, each of the negative electrode current collector 32, the negative electrode 22, the solid-state electrolyte 26, the positive electrode 24, and the positive electrode current collector 34 are prepared as relatively thin layers (for example, from several microns to a millimeter or less in thickness) and assembled in layers connected in electrical parallel arrangement to provide a suitable electrical energy and power package. In various other instances, the battery 20 may include electrodes 22, 24 connected in series.

Further, in certain aspects, the battery 20 may include a variety of other components that, while not depicted here, are nonetheless known to those of skill in the art. For instance, the battery 20 may include a casing, a gasket, terminal caps, and any other conventional components or materials that may be situated within the battery 20, including between or around the negative electrode 22, the positive electrode 24, and/or the solid-state electrolyte 26, by way of non-limiting example. As noted above, the size and shape of the battery 20 may vary depending on the particular applications for which it is designed. Battery-powered vehicles and hand-held consumer electronic devices are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42.

Accordingly, the battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the battery 20 for purposes of storing energy.

With continued reference to FIG. 1, the solid-state electrolyte 26 provides electrical separation—preventing physical contact—between the negative electrode 22, i.e., an anode, and the positive electrode 24, i.e., a cathode. The solid-state electrolyte 26 also provides a minimal resistance path for internal passage of ions. In various aspects, as noted above, the first plurality of solid-state electrolyte particles 30 may define the solid-state electrolyte 26. For example, the solid-state electrolyte 26 may be in the form of a layer or a composite that comprises the first plurality of solid-state electrolyte particles 30. For example, the solid-state electrolyte 26 may be in the form of a layer having a thickness greater than or equal to about 1 μm to less than or equal to about 1 mm, and in certain aspects, optionally greater than or equal to about 1 μm to less than or equal to about 100 μm. Such solid-state electrolytes 26 may have an interparticle porosity 80 (defined herein as a fraction of the total volume of pores over the total volume of the layer or film being described) between the first plurality of solid-state electrolyte particles 30 that is greater than 0 vol. % to less than or equal to about 50 vol. %, greater than or equal to about 1 vol. % to less than or equal to about 40 vol. %, or greater than or equal to about 2 vol. % to less than or equal to about 20 vol. %.

The first plurality of solid-state electrolyte particles 30 comprise LLZO. LLZO has the formula Li₇La₃Zr₂O₁₂ and a tetrahedral structure, which has a low ionic conductivity. Therefore, the LLZO comprises a dopant, which provides the LLZO with a garnet crystal structure and a relatively higher ionic conductivity. As non-limiting examples, the dopant comprises aluminum (Al³⁺, from, for example, Al₂O₃), tantalum (Ta⁵⁺, from, for example, TaCl₅), niobium (Nb⁵⁺, from, for example, Nb(OCH₂CH₃)₅), gallium (Ga³⁺, from, for example, Ga₂O₃), indium (In³⁺, from, for example, In₂O₃), tin (Sn⁴⁺, from, for example, SnO₄), antimony (Sb⁴⁺, from, for example, Sb₂O₃), bismuth (Bi⁴⁺, from, for example, Bi₂O₃), yttrium (Y³⁺, from, for example, Y₂O₃), germanium (Ge⁴⁺, from, for example, GeO₂), zirconium (Zr⁴⁺, from, for example, ZrO₂), calcium (Ca²⁺, from, for example, CaCl), strontium (Sr²⁺, from, for example, SrO), barium (Ba²⁺, from, for example, BaO), hafnium (Hf⁴⁺, from, for example, HfO₂), or combinations thereof. Therefore, the stoichiometry of the first plurality of solid-state electrolyte particles 30 may change when a dopant is present. As used herein, unless indicated otherwise, the solid-state electrolyte particles are doped, i.e., the LLZO is doped Li₇La₃Zr₂O₁₂ having a garnet crystal structure, which can be Li_{7-3x-y}AlₓLa₃Zr_{2-y}M_{y}O₁₂, where M is Ta and/or Nb, 0≤x≤1, and 0≤y≤1; Li_{6.5}La₃Zr_{1.5}M_{0.5}O₁₂, where M is Nb and/or Ta; Li₇₋ₓLa₃Zr₂₋ₓBiₓO₁₂, where 0≤x≤1; and Li_{6.5}Ga_{0.2}La_{2.9}Sr_{0.1}Zr₂O₁₂, as non-limiting examples. In various aspects, the first plurality of solid-state electrolyte particles 30 alternatively or also comprise LiₓLa_{y}TiO₃, where 0<x<1 and 0<y<1 (LLTO); Li₁₊ₓAl_{y}Ti_{2-y}PO₄, where 0<x<1 and 0<y<2 (LATP); Li₂₊₂ₓZn₁₋ₓGeO₄, where 0<x<1 (LISICON); Li₂PO₂N (UPON); and combinations thereof, as non-limiting examples.

Ceramic oxide solid-state electrolyte particles of the first plurality of solid-state electrolyte particles 30 can be made by a solid-state combination of precursors using ball milling or through the synthesis of a sol-gel, where precursors are dissolved in a solvent, solidified, and dried. The milled or solidified precursors are then calcined (optionally in a die defining a predetermined shape) at a temperature of greater than or equal to about 700° C. to less than or equal to about 1200° C. to form a green, non-densified ceramic oxide solid-state electrolyte structure, which is optionally crushed into a powder. The green ceramic oxide solid-state electrolyte structure, shaped or in powder form, may react with atmospheric H₂O and CO₂ and form a surface layer comprising LiOH, Li₂CO₃, or combinations thereof, which at least partially coats each solid-state electrolyte particle of the first plurality of solid-state electrolyte particles 30. Therefore, hydroxide and carbonate layers often form on surfaces of solid-state electrolyte particles. Although the carbonate can be decomposed by sintering at a temperature of about 1000° C., doing so generates surface contaminates, such as electrically conductive carbon, which promotes dendrite formation. Accordingly, methods of removing and replacing the layer comprising LiOH, Li₂CO₃, or combinations thereof with a layer that conducts lithium ions without the need to decompose the carbonate are discussed below.

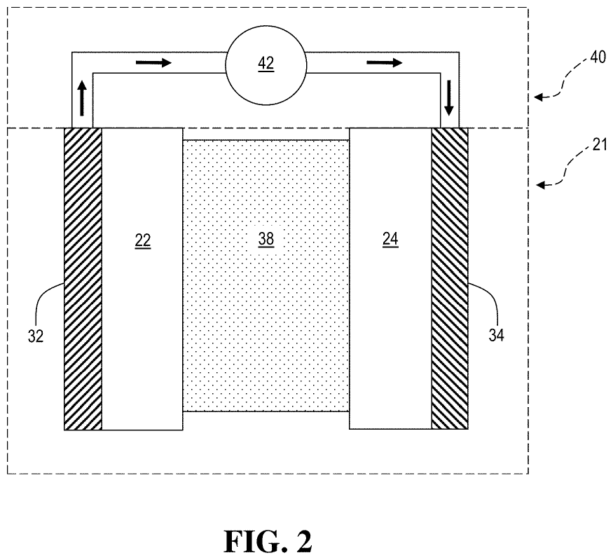

With reference to FIG. 2, the current technology also considers a secondary battery 21 that cycles lithium ions, i.e., a lithium-ion battery. The components of the secondary battery 21 having equivalent corresponding components in the battery 20 of FIG. 1 are labeled with the same numerals. As such, the secondary battery 21 comprises the negative electrode 22, the negative electrode current collector 32, the positive electrode 24, and the positive electrode current collector 34. However, the secondary battery 21 does not include a solid-state electrolyte. Rather, the secondary battery 21 comprises a separator 38 disposed between the negative electrode 22 and the positive electrode 24. The separator 38 operates as an electrical insulator by being sandwiched between the negative electrode 22 and the positive electrode 24 to prevent physical contact and, thus, the occurrence of a short circuit. A liquid electrolyte solution is present throughout the separator 38 and, optionally, in the negative electrode 22 and/or in the positive electrode 24. Therefore, in addition to providing a physical barrier between the electrodes 22, 24, the separator 38 acts like a sponge that contains the electrolyte solution in a network of open pores during the cycling of lithium ions to facilitate functioning of the secondary battery 21. As discussed above, the chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode, are concurrently transferred through the liquid electrolyte solution contained in the separator 38 towards the positive electrode 24. The electrons flow through the external circuit 40 and the lithium ions migrate across the separator 38 containing the electrolyte solution to form intercalated lithium at the positive electrode 24.

The separator 38 operates as both an electrical insulator and a mechanical support. In one embodiment, a microporous polymeric separator 38 comprises a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer.

When the separator 38 is a microporous polymeric separator, it may be a single layer or a multi-layer laminate, which may be fabricated from either a dry or wet process. For example, in one embodiment, a single layer of the polyolefin may form the entire microporous polymeric separator 38. In other aspects, the separator 38 may be a fibrous membrane having an abundance of pores extending between the opposing surfaces and may have a thickness of less than a millimeter, for example. As another example, multiple discrete layers of similar or dissimilar polyolefins may be assembled to form the microporous polymeric separator 38. The polyolefins may be homopolymers (derived from a single monomer constituent) or heteropolymers (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyacrylonitrile (PAN), polyvinylidene fluoride (PVDF), polyethylene (PE), polypropylene (PP), a blend of PE and PP, multi-layered structured porous films of PE and/or PP, and copolymers thereof. The microporous polymeric separator 38 may also comprise other polymers in addition to the polyolefin, such as, but not limited to, polyethylene terephthalate (PET) and/or a polyamide. Commercially available polyolefin porous membranes include CELGARD® 2500 (a monolayer polypropylene separator) and CELGARD® 2320 (a trilayer polypropylene/polyethylene/polypropylene separator), both available from Celgard, LLC. The polyolefin layer and any other optional polymer layers may further be included in the microporous polymeric separator 38 as a fibrous layer to help provide the microporous polymeric separator 38 with appropriate structural and porosity characteristics. Various conventionally available polymers and commercial products for forming the separator 38 are contemplated. The many manufacturing methods that may be employed to produce such microporous polymeric separators 38 are also contemplated.

When a polymer, the separator 38 may be mixed with a ceramic material or its surface may be coated in a ceramic material. For example, a ceramic coating may include ceramic oxides such as alumina (Al₂O₃), silicon dioxide (SiO₂), titania (TiO₂), LLZO, LLTO, LATP, LISICON, LIPON, or combinations thereof. In various alternative embodiments, instead of a polymeric material as discussed above, the separator 38 comprises a green ceramic oxide (i.e., a ceramic oxide that has not been sintered or otherwise densified) having a high porosity of greater than or equal to about 10 vol. % to less than or equal to about 50 vol. %.

Any appropriate liquid electrolyte solution capable of conducting lithium ions between the negative electrode 22 and the positive electrode 24 may be used in the secondary battery 21. In certain aspects, the electrolyte solution may be a nonaqueous liquid electrolyte solution including a lithium salt dissolved in an organic solvent or a mixture of organic solvents. Numerous conventional nonaqueous liquid electrolyte solutions may be employed in the secondary battery 21. A non-limiting list of salts that may be dissolved in an organic solvent to form the nonaqueous liquid electrolyte solution includes LiPF₆, LiFSi, LiClO₄, LiAlCl₄, LiI, LiBr, LiSCN, LiBF₄, LiB(C₆H₅)₄, LiB(C₂O₄)₂, LiAsF₆, LiCF₃SO₃, LiN(CF₃SO₂)₂, Li(CF₃SO₂)₂N, and combinations thereof. These and other similar salts may be dissolved in a variety of organic solvents, including, but not limited to, various alkyl carbonates, such as cyclic carbonates (ethylene carbonate (EC), propylene carbonate (PC), butylene carbonate(BC)), acyclic carbonates (dimethyl carbonate (DMC), diethyl carbonate (DEC), ethyl methyl carbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

Referring back to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 10 wt. % to less than or equal to about 95 wt. %, and in certain aspects, optionally greater than or equal to about 50 wt. % to less than or equal to about 90 wt. %, of the negative solid-state electroactive particles 50 and greater than or equal to about 5 wt. % to less than or equal to about 90 wt. %, and in certain aspects, optionally greater than or equal to about 10 wt. % to less than or equal to about 40 wt. %, of the second plurality of solid-state electrolyte particles 90. Such negative electrodes 22 may have an interparticle porosity 82 between the negative solid-state electroactive particles 50 and/or the second plurality of solid-state electrolyte particles 90 that is greater than or equal to about 0 vol. % to less than or equal to about 20 vol. %. The second plurality of solid-state electrolyte particles 90 may be the same as or different from the first plurality of solid-state electrolyte particles 30.

In certain variations, the negative solid-state electroactive particles 50 may be lithium-based, for example, a lithium alloy. In other variations, the negative solid-state electroactive particles 50 may be silicon-based comprising, for example, a silicon alloy. In still other variations, the negative electrode 22 may be a carbonaceous anode and the negative solid-state electroactive particles 50 may comprise one or more negative electroactive materials, such as graphite, graphene, and carbon nanotubes. In still further variations, the negative electrode 22 may comprise one or more negative electroactive materials, such as lithium titanium oxide (Li₄Ti₅O₁₂); one or more metal oxides, such as V₂O₅; and metal sulfides, such as FeS.

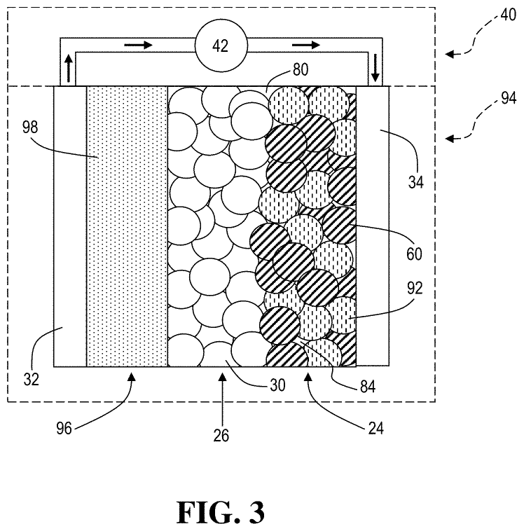

An all-solid-state metal battery 94 is shown in FIG. 3. Components of the all-solid-state metal battery 94 share reference numerals with the battery 20 that cycles lithium ions of FIG. 1. Accordingly, the all-solid-state metal battery 94 has the same positive electrode 24, i.e., cathode, and solid-state electrolyte 26 as the battery 20 that cycles ions. However, the all-solid-state metal battery 94 has a negative electrode 96, i.e., anode, comprising a solid film 98 of lithium metal. Therefore, the negative electrode 96 does not comprise a composite material.

Referring back to FIG. 1, in certain variations, the negative solid-state electroactive particles 50 may be optionally intermingled with one or more electrically conductive materials that provide an electron conduction path and/or at least one polymeric binder material that improves the structural integrity of the negative electrode 22. For example, the negative solid-state electroactive particles 50 may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene, and the like. Examples of a conductive polymer may include polyaniline, polythiophene, polyacetylene, polypyrrole, and the like. In certain variations, conductive additives may include, for example, one or more non-carbon conductive additives selected from simple oxides (such as RuO₂, SnO₂, ZnO, Ge₂O₃), superconductive oxides (such as YBa₂Cu₃O₇, La_{0.75}Ca_{0.25}MnO₃), carbides (such as SiC₂), silicides (such as MoSi₂), and sulfides (such as CoS₂).

In certain aspects, such as when the negative electrode 22 (i.e., anode) does not include lithium metal, mixtures of the conductive materials may be used. For example, the negative electrode 22 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The negative electrode current collector 32 may be formed from copper or any other appropriate electrically conductive material known to those of skill in the art.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 10 wt. % to less than or equal to about 95 wt. %, and in certain aspects, optionally greater than or equal to about 50 wt. % to less than or equal to about 90 wt. %, of the positive solid-state electroactive particles 60 and greater than or equal to about 5 wt. % to less than or equal to about 70 wt. %, and in certain aspects, optionally greater than or equal to about 10 wt. % to less than or equal to about 30 wt. %, of the third plurality of solid-state electrolyte particles 92. Such positive electrodes 24 may have an interparticle porosity 84 between the positive solid-state electroactive particles 60 and/or the third plurality of solid-state electrolyte particles 92 that is greater than or equal to about 1 vol. % to less than or equal to about 20 vol. %, and optionally greater than or equal to 5 vol. % to less than or equal to about 10 vol. %. In various instances, the third plurality of solid-state electrolyte particles 92 may be the same as or different from the first and/or second pluralities of solid-state electrolyte particles 30, 90.

In various aspects, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNiₓMn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by Al₂O₃) and/or the positive electroactive material may be doped (for example, by magnesium).

In certain variations, the positive solid-state electroactive particles 60 may be optionally intermingled with one or more electrically conductive materials that provide an electron conduction path and/or at least one polymeric binder material that improves the structural integrity of the positive electrode 24. For example, the positive solid-state electroactive particles 60 may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer may include polyaniline, polythiophene, polyacetylene, polypyrrole, and the like.

In certain aspects, mixtures of the conductive materials may be used. For example, the positive electrode 24 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The positive electrode current collector 34 may be formed from aluminum or any other electrically conductive material known to those of skill in the art.

As a result of the interparticle porosity 80, 82, 84 between particles within the battery 20 (for example, the battery 20 in a green form may have a solid-state electrolyte interparticle porosity greater than or equal to about 10 vol. % to less than or equal to about 50 vol. %), direct contact between the solid-state electroactive particles 50, 60 and the pluralities of solid-state electrolyte particles 30, 90, 92 may be much lower than the contact between a liquid electrolyte and solid-state electroactive particles in comparable non-solid-state batteries. To improve contact between the solid-state electroactive particles and solid-state electrolyte particles, the amount of the solid-state electrolyte particles may be increased within the electrodes.

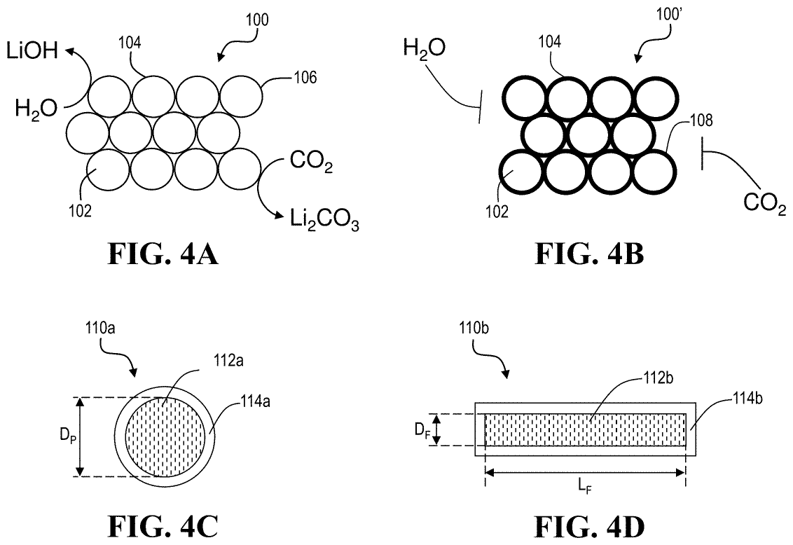

As discussed above, various electrochemical cell components comprise doped LLZO, including Li_{7-3x-y}AlₓLa₃Zr_{2-y}M_{y}O₁₂, where M is Ta, Nb, or a combination thereof, 0≤x≤1, and 0≤y≤1; Li_{6.5}La₃Zr_{1.5}M_{0.5}O₁₂, where M is Nb, Ta, or a combination thereof; Li₇₋ₓLa₃Zr₂₋ₓBiₓO₁₂, where 0≤x≤1; L_{6.2}Ga_{0.3}La_{2.95}Rb_{0.05}Zr₂O₁₂; La_{6.65}Ga_{0.15}La₃Zr_{1.9}Sc_{0.1}O₁₂; and combinations thereof. The electrochemical cell components are, as non-limiting examples, a solid-state electrolyte comprising LLZO, a separator comprising LLZO, a coating comprising LLZO disposed on a separator, a positive electrode comprising a positive electrode active material having a solid-state electrolyte comprising LLZO embedded therein, or a negative electrode comprising a negative electrode active material having a solid-state electrolyte comprising LLZO embedded therein. LLZO of the electrochemical cell components reacts with atmospheric H₂O and CO₂ to form a surface carbonate layer comprising LiOH and Li₂CO₃, respectively. As such, a single layer comprising LiOH and Li₂CO₃or a bilayer comprising a first layer of LiOH and a second layer of Li₂CO₃ coats the LLZO. The layer or layers of LiOH and Li₂CO₃ do not adequately conductions and result in a high interfacial impedance. For example, FIG. 4A shows a layer 100 comprising LLZO particles 102. Atmospheric H₂O and CO₂ react with the LLZO to form LiOH and Li₂CO₃, respectively, on surfaces 104 of the LLZO particles 102 as a layer or bilayer 106. The layer or bilayer 106 is substantially non-conductive to lithium ions. As used herein, the term “substantially non-conductive to lithium ions and sodium ions” means that the layer or bilayer 106 comprising the solid-state electrolyte particles has a conductivity of less than or equal to about 0.01 mS/cm at about 20° C. Although the carbonate of the layer or bilayer 106 can be decomposed by sintering at high temperatures of over 1000° C., this decomposition results in an additional loss of lithium (due to evaporation at this high temperature) and a generation of surface contaminants. One such surface contaminant is carbon, which is electronically conductive and promotes dendrite formation.

Accordingly, the current technology provides a method of removing a layer or bilayer comprising LiOH and Li₂CO₃ formed on a surface of LLZO and replacing the layer or bilayer with a layer of Li₃PO₄. For instance, FIG. 4B shows a layer 100′ comprising the LLZO particles 102 of FIG. 4A. However, the layer or bilayer 106 is removed and replaced with a layer comprising Li₃PO₄ 108 to form Li₃PO₄-coated LLZO. The LLZO layer 100′ comprising the Li₃PO₄ 108 is conductive to ions, such as lithium ions, and is non-reactive to atmospheric H₂O and CO₂.

The current technology also provides Li₃PO₄-coated LLZO. The Li₃PO₄-coated LLZO comprises a core and a layer comprising Li₃PO₄ disposed on at least a portion of the core. The core can be in any form known in the art, including a particle, a plurality of which forms a powder, a fiber, and a nanowire, as non-limiting examples. When used with reference to Li₃PO₄-coated LLZO, the term “material” refers to the Li₃PO₄-coated LLZO being in particle (powder) or nanofiber (nanowire) form. As such, a Li₃PO₄-coated LLZO material can be particles comprising Li₃PO₄-coated LLZO or nanofibers (or nanowires) comprising Li₃PO₄-coated LLZO. Films, including green films and sintered films, can be made from any Li₃PO₄-coated LLZO material described herein.

FIG. 4C is a cross-sectional view of a Li₃PO₄-coated LLZO particle 110a comprising a core 112a in the form of a substantially spherical particle comprising the LLZO and a layer comprising the Li₃PO₄ 114a directly or indirectly coating at least a portion of the core 112a. As used herein, the term “substantially spherical” is understood to mean that the particles are not perfect spheres, but can have some flat edges or other irregularities. The particle core 112a has a diameter D_{P} (or a longest dimension) less than or equal to about 100 μm, such as greater than or equal to about 100 nm to less than or equal to about 100 μm, including diameters Dₚ of about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 10 μm, about 20 μm, about 30 μm, about 40 μm, about 50 μm, about 60 μm, about 70 μm, about 80 μm, about 90 μm, or about 100 μm.

FIG. 4D is a cross-sectional view of a Li₃PO₄-coated LLZO nanowire or nanofiber or microwire or microfiber 110b comprising an elongate core 112b in the form of a nanowire or nanofiber (the terms “nanowire” and “nanofiber” being used interchangeably herein) comprising the LLZO and a layer comprising the Li₃PO₄ 114b directly or indirectly coating at least a portion of the elongate core 112b. The elongate core 112b has a length L_{F} less than or equal to about 10 mm, such as greater than or equal to about 1 μm to less than or equal to about 10 mm, including lengths L_{F} of about 1 μm, about 50 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 2 mm, about 3 mm, about 4 mm, about 5 mm, about 6 mm, about 7 mm, about 8 mm, about 9 mm, or about 10 mm and a fiber diameter DF less than or equal to about 100 μm, such as greater than or equal to about 100 nm to less than or equal to about 100 μm, including fiber diameters D_{F} of about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 10 μm, about 20 μm, about 30 μm, about 40 μm, about 50 μm, about 60 μm, about 70 μm, about 80 μm, about 90 μm, or about 100 μm. Therefore, the particle or fiber core 112a, 112b has at least one dimension that is less than or equal to about 100 μm.

With further reference to FIGS. 4C-4D, in some aspects, substantially all of the core 112a, 112b is coated with the layer comprising the Li₃PO₄ 114a, 114b. As used herein, “substantially all of the core 112a, 112b is coated” means that greater than or equal to about 80% of the surface of the core 112a, 112b is coated with the layer comprising the Li₃PO₄ 114a, 114b. As such, the layer comprising the Li₃PO₄ 114a, 114b is continuous or discontinuous. Moreover, the layer comprising the Li₃PO_{4 114}a, 114b resists atmospheric H₂O and CO₂. In some aspects, the layer comprising the Li₃PO₄ 114a, 114b consists of or consists essentially of Li₃PO₄. By “consists essentially of,” it is meant that the layer comprising the Li₃PO₄ 114a, 114b can include additional components only if they (individually or collectively) do not affect the layer's ability to resist atmospheric H₂O and CO₂ and they (individually or collectively) do not substantially affect the layer's ionic conductivity or uniform current density. By “substantially” it is meant that the additional components do not affect the layer's ability to resist atmospheric H₂O and CO₂ by greater than or equal to about 10% and that the additional components do not decrease the layer's ionic conductivity or uniform current density by greater than or equal to about 10%.

The Li₃PO₄-coated LLZO particle 110a, 110b is suitable for incorporation in at least one component of an electrochemical cell that cycles lithium ions. Non-limiting examples of components that benefit from the Li₃PO₄-coated LLZO particle 110a, 110b include a solid-state electrolyte, a separator, a coating on a separator, a positive electrode, a negative electrode, and combinations thereof.

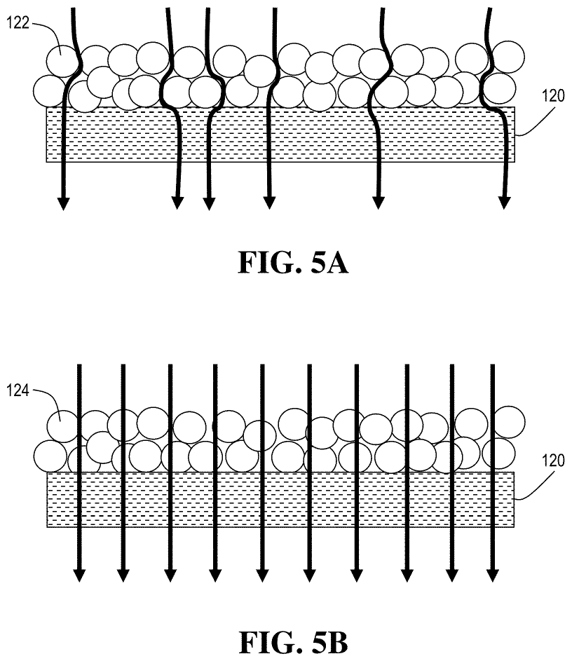

An example of the benefits provided by the Li₃PO₄-coated LLZO of the current technology is shown in FIGS. 5A-5B. FIG. 5A shows a polymeric separator 120 that includes a coating 122 comprising Al₂O₃ and/or SiO₂ particles, which are ionically insulating. As shown by the curved arrows, the coating 122 exhibits a non-uniform current density, which is associated with resistance. However, FIG. 5B shows the polymeric separator 120 including a second coating 124 comprising the Li₃PO₄-coated LLZO of the current technology, which is ionically conductive. As shown by the straight arrows, the second coating 124 exhibits a uniform, or relatively more uniform, current density, which is associated with relatively decreased resistance.

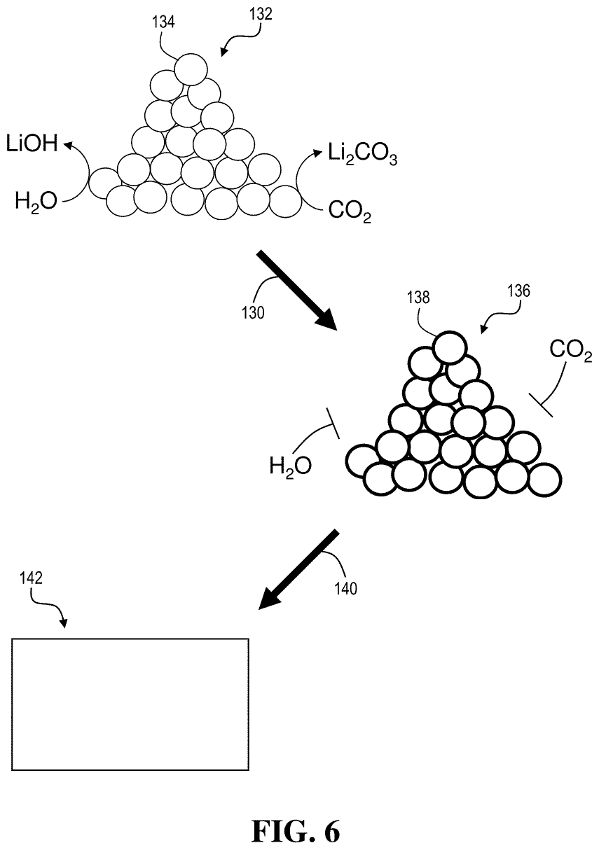

With reference to FIG. 6, the current technology provides a method 130 of fabricating a component of an electrochemical cell, such as a component of any electrochemical cell discussed above. In particular, the method 130 comprises obtaining LLZO 132 and forming Li₃PO₄-coated LLZO 136 from the LLZO 132. Here, the Li₃PO₄-coated LLZO 136 is the component being fabricated. The LLZO 132 comprises a surface layer or a surface bilayer 134 of LiOH and/or Li₂CO₃, which results from a LLZO synthesis procedure or from exposing LLZO to air. As shown in the figure, the LLZO 132 is in the form of particles that collectively form a powder. However, the form of the LLZO 132 is not limited and can be, for example, a nanowire (or plurality of nanowires) or a fiber (or a plurality of fibers), as discussed above. The Li₃PO₄-coated LLZO 136 is substantially free of the surface layer or the surface bilayer 134. By “substantially free of the surface layer or the surface bilayer 134,” it is meant that less than or equal to about 50 vol. % or less than or equal to about 25 vol. % of the surface layer or the surface bilayer 134 remains after the method 130 is performed. The resulting Li₃PO₄-coated LLZO 136 comprises a LLZO core and a layer comprising Li₃PO₄ 138 disposed on the LLZO core, as described above with reference to FIGS. 4C-4D.

With further reference to FIG. 6, the method 130 comprises adding the LLZO 132 to a H₃PO₄ solution to form a suspension. The H₃PO₄ solution comprises greater than or equal to about 1 wt. % to less than or equal to about 87 wt. % H₃PO₄ in water and/or anhydrous ethanol (EtOH), such as about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 87 wt. % H₃PO₄ (at room temperature). The H₃PO₄ solution comprises water and optionally the anhydrous EtOH. When present, the anhydrous EtOH is included at a concentration of greater than about 0 vol. % to less than or equal to about 99 vol. %. The H₃PO₄ solution also optionally comprises a sufficient amount of sodium hydroxide (NaOH) to result in a pH greater than or equal to about 11.5 or greater than or equal to about 12, such as a pH of about 11.5, about 12, about 12.5, or higher. This pH ensures that the H₃PO₄ fully dissociates to form the layer comprising Li₃PO₄ 138 and not a layer comprising LiH₂PO₄. However, because the LLZO 132 removes protons from the solutions, the LLZO 132 may sufficiently increase the pH of the solution so that the NaOH is not necessary to fully dissociate the H₃PO₄. The method 130 then comprises incubating the suspension until the suspension is substantially free of generating CO₂ to form the Li₃PO₄-coated LLZO 136. When the LLZO 132 is added to the H₃PO₄ solution, an evolution of CO₂ causes bubbling. Therefore, incubating the suspension until the suspension is substantially free of generating CO₂ comprises incubating the suspension until bubbles are no longer visible (it may be acceptable to stop the incubation when bubble formation is very slow, such as fewer than about 10 or about 20 bubbles being visible in about 1 minute). The Li₃PO₄-coated LLZO 136 is then separated from the H₃PO₄ solution, such as by filtering; washed, e.g., by rinsing with anhydrous EtOH; and dried, e.g., by incubating at a temperature greater than or equal to about room temperature to less than or equal to about 100° C. (or higher) for greater than or equal to about 5 minutes to less than or equal to about 48 hours (although heating for longer than 48 hours may not have deleterious effects).

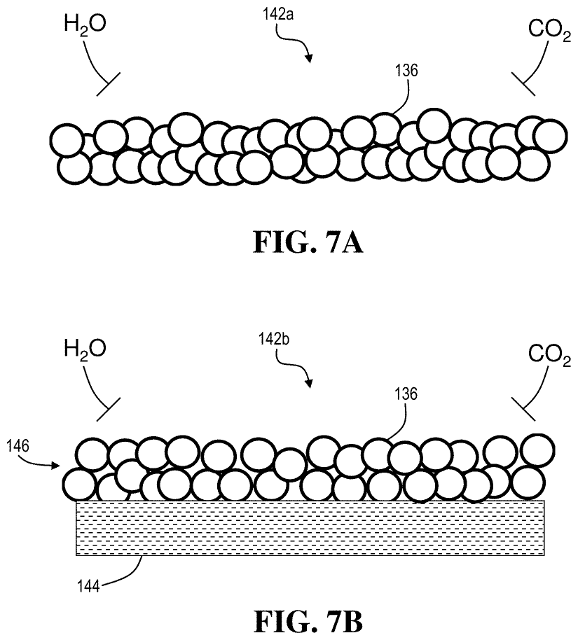

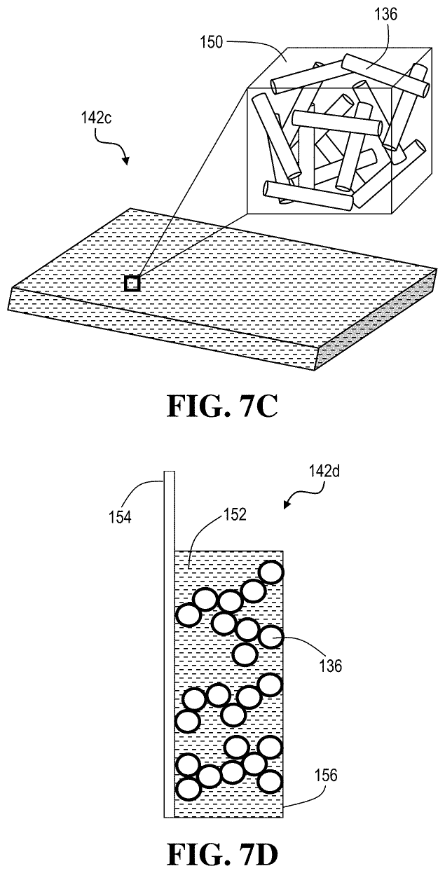

As shown in FIG. 6, a second method 140 is performed on the Li₃PO₄-coated LLZO 136 to form a second component 142 of an electrochemical cell that cycles lithium ions, such as any electrochemical cell described above. The second method 140 and the second component 142 are further discussed with reference to FIGS. 7A-7D.

The second method 140 of FIG. 6 can be performed in order to fabricate a solid-state electrolyte 142a, as shown in FIG. 7A. This method comprises optionally combining a powder of the Li₃PO₄-coated LLZO 136 with a sacrificial binder and pressing the powder between a pair of platens to form a green film or pellet. Non-limiting examples of the optional sacrificial binder include ethylene propylene diene monomer (EPDM) rubber, nitrile butadiene rubber (NBR), styrene-butadiene rubber (SBR), lithium polyacrylate (LiPAA), sodium polyacrylate (NaPAA), poly(propylene) carbonate (PPC), poly(vinylpyrrolidone) (PVP), poly(vinyl alcohol) (PVA), polyethylene oxide (PEO), polyacrylonitrile (PAN), polyacrylamide, acrylics, methylcellulose, polyethylenimine, hydroxypropylmethylcellulose, hydroxyethylcellulose, sodium carboxymethylcellulose (Na-CMC), xanthan gum, gum Arabic, guar gum, sodium alginate, ammonium alginate, lignosulfonates, lignin liquor, dextrins, starch, scleroglucan, cationic galactomannan, and combinations thereof. The method then comprises sintering or hot pressing the green film or pellet to burn out the sacrificial binder, when present, and to consolidate the Li₃PO₄-coated LLZO 136 to form the solid-state electrolyte 142a. Because Li₃PO₄ has a melting temperature greater than about 1200° C., sintering can be performed at temperatures of greater than or equal to about 900° C. to less than or equal to about 1100° C., including temperatures of about 900° C., about 950° C., about 1000° C., about 1050° C., and about 1100° C., without melting. As such, the Li₃PO₄ remains at grain boundaries after sintering. The Li₃PO₄-coated LLZO 136 of the solid-state electrolyte 142a (which is sintered) has a porosity of less than or equal to about 10 vol. %. The solid-state electrolyte 142a can be incorporated between an anode and a cathode in a solid-state electrochemical cell.

The second method 140 of FIG. 6 can also be performed in order to fabricate a coated polymeric separator 142b comprising a polymeric separator 144 and a film 146 comprising the Li₃PO₄-coated LLZO 136 disposed on at least one surface of the polymeric separator 144, as shown in FIG. 7B. Here, the method comprises combining the powder with a binder, a surfactant, and a solvent to form a slurry; casting the slurry onto the at least one surface of the polymeric separator 144; and drying the slurry to form the film 146 comprising the Li₃PO₄-coated LLZO 136 on the surface of the polymeric separator 144. The binder can be PVP, PAN, PVA, PVDF, LiPAA, NaPAA, Na-CMC, Na alginate, and combinations thereof, as non-limiting examples, and is included from greater than or equal to about 1 wt. % to less than or equal to about 50 wt. %, where the wt. % refers to the total weight of the LLZO and binder only. The surfactant can be Titon X100, Tween 20, oleic acid, and combinations thereof, as non-limiting examples. The solvent can be dimethylformamide (DMF), acetone, acetonitrile, water, and combinations thereof, as non-limiting examples.

The second method 140 of FIG. 6 can also be performed in order to fabricate a composite polymeric separator 142c comprising a polymeric matrix 150 and the Li₃PO₄-coated LLZO 136 embedded throughout the polymeric matrix 150, as shown in FIG. 7C. Here, the method comprises combining the Li₃PO₄-coated LLZO 136 with a polymer electrolyte, a surfactant, and a solvent to form a slurry and casting the slurry on a substrate. The Li₃PO₄-coated LLZO 136 can be in the form of a powder, fibers, nanowires, or combinations thereof. The method then comprises removing at least a portion of the solvent to form the composite polymeric separator 142c comprising the polymeric matrix 150 and the Li₃PO₄-coated LLZO 136. The method also includes removing the composite polymeric separator 142c from the substrate to yield the composite polymeric separator 142c as a stand-alone electrolyte film.

The second method 140 of FIG. 6 can also be performed in order to fabricate a positive or negative electrode 142d having the Li₃PO₄-coated LLZO 136 disposed therein, as shown in FIG. 7D. The positive or negative electrode 142d comprises an electrode active material 152 disposed on a current collector 154. The Li₃PO₄-coated LLZO 136 is embedded in the electrode active material 152 such that the Li₃PO₄-coated LLZO 136 is at a surface 156 that will be contact with a separator or solid-state electrolyte. Here, the method comprises combining the electrode active material 152 (which may be a positive electrode active material or a negative electrode active material) with the Li₃PO₄-coated LLZO 136 and a binder to form a slurry and casting the slurry on a substrate. The method then includes drying the slurry to form the positive or negative electrode 142d, which is then removed from the substrate.

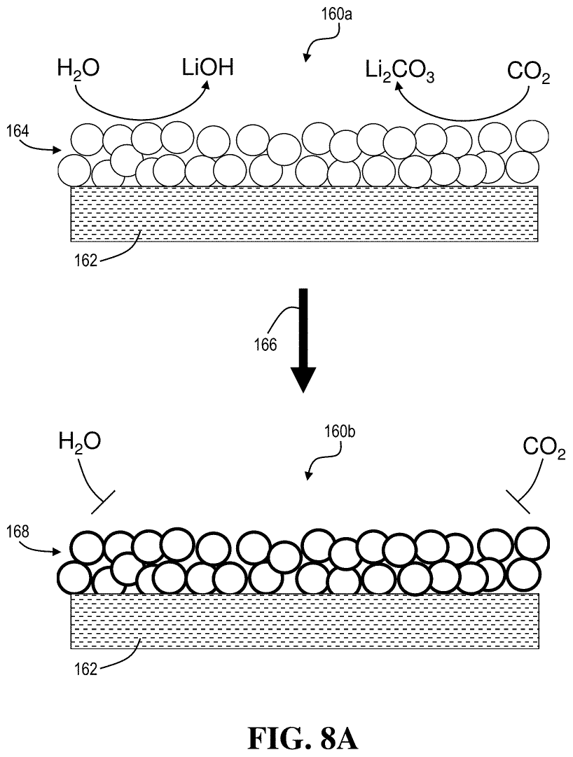

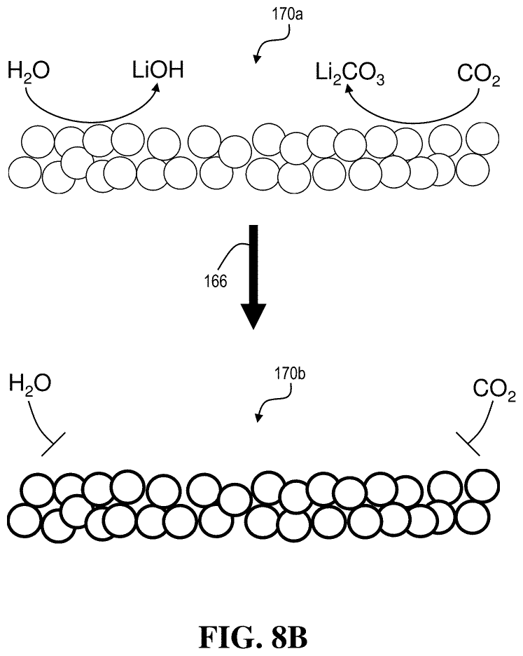

The above-described method of replacing a LiOH and/or Li₂CO₃ layer or bilayer with a layer comprising Li₃PO₄-coated LLZO can also be performed on a component that comprises LLZO within the layer or bilayer. For example, FIG. 8A shows a coated separator 160a comprising a polymeric separator 162 and a layer (or film) comprising LLZO 164 disposed on the polymeric separator 162. The coated separator 160a is formed by casting a slurry comprising the LLZO onto a surface of the polymeric separator 162 and drying the slurry to form the layer (or film) comprising LLZO 164 on a surface of the polymeric separator 162, thereby forming the coated separator 160a. Next, a method 166 comprises contacting the layer (or film) comprising LLZO 164 of the coated separator 160a with a H₃PO₄ solution as described above, including a binder that is insoluble in the solvents of the H₃PO₄ solution. When the bubbling caused by CO₂ evolution is no longer visible, a Li₃PO₄-coated separator 160b is formed, which is separated from the H₃PO₄ solution. The Li₃PO₄-coated separator 160b comprises the polymeric separator 162 and a layer 168 comprising Li₃PO₄-coated LLZO disposed on the polymeric separator 162.

Similarly, FIG. 8B shows a solid-state separator 170a comprising LLZO having a LiOH and/or Li₂CO₃layer or bilayer. The solid-state separator 170a can be formed, for example, by delaminating the layer comprising LLZO 164 from the polymeric separator 162, as shown in FIG. 8A. The solid-state separator 170a is formed by casting a slurry comprising the LLZO onto a substrate and drying the slurry to form the solid-state separator 170a, which is then removed from the substrate. Next, the method 166 is performed, which comprises contacting the solid-state separator 170a with the H₃PO₄ solution. When the bubbling caused by CO₂ evolution is no longer visible, a solid-state separator 170b comprising Li₃PO₄-coated LLZO is formed, which is separated from the H₃PO₄ solution. The Li₃PO₄-coated LLZO of the solid-state separator 170b has a porosity of greater than or equal to about 10 vol. % to less than or equal to about 50 vol. %.

Embodiments of the present technology are further illustrated through the following non-limiting example.

### EXAMPLE

A method is performed to remove a layer or bilayer comprising LiOH and/or Li₂CO₃ from the surface of LLZO particles and replace the layer or bilayer with a layer comprising Li₃PO₄ to form Li₃PO₄-coated LLZO. The method includes making a phosphoric acid solution by mixing the following into 2 g of deionized water: (a) 1 g of 85 wt. % H₃PO₄ in water, (b) 3.3 g anhydrous EtOH, and (c) 0.1 g NaOH. LLZO powder comprising the layer or bilayer is added to the phosphoric acid solution and stirred until bubbling ceases (about 1 minute). The LLZO is filtered, rinsed with anhydrous EtOH, and dried overnight at about 80 ° C. to form the Li₃PO₄-coated LLZO.

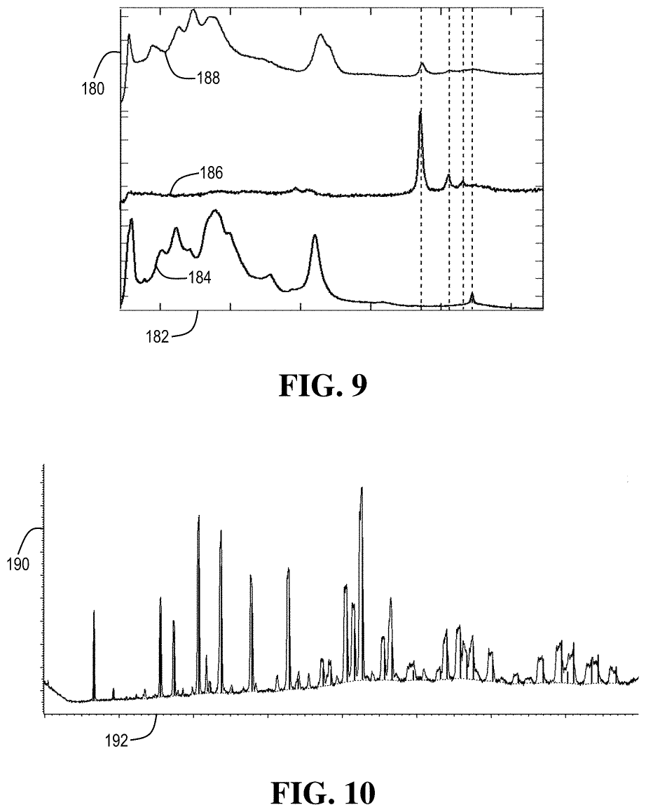

Raman spectroscopy is performed to determine the composition of the Li₃PO₄ coating. The results are shown in FIG. 9, which is a graph having a y-axis 180 representing intensity (units) and an x-axis 182 representing wavenumber (from about 100 cm⁻¹ to about 1300 cm⁻¹). Spectra for a LLZO standard 184, a Li₃PO₄ standard 186, and the Li₃PO₄-coated LLZO 188 are shown. The results show the Li₃PO₄-coated LLZO does not include LiOH or Li₂CO₃, but does include Li₃PO₄.

The Li₃PO₄-coated LLZO is also subjected to an x-ray powder diffraction analysis. The results are shown in FIG. 10, which is a graph having a y-axis 190 representing counts (from 0 to 10,700) and an x-axis 192 representing 2θ (from 10 to 90). The peak broadening and twinning suggests that Li⁺ is being replaced with H+ during a proton exchange during acid treatment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, the electrochemical cell comprising:
a positive electrode comprising a positive lithium-based electroactive material and one or more polymeric binder materials;
a negative electrode comprising a negative electroactive material;
a separator disposed between the positive electrode and the negative electrode; and
a lithium phosphate (Li₃PO₄)-coated lithium lanthanum zirconium oxide (LLZO) material,
wherein the Li₃PO₄-coated LLZO material is:
a particle having a substantially spherical core comprising the LLZO and a layer comprising the Li₃PO₄ directly coating at least a portion of the substantially spherical core, the substantially spherical core having a diameter of less than or equal to about 100 μm;
a nanowire having an elongate core comprising the LLZO and a layer comprising the Li₃PO₄ directly coating at least a portion of the elongate core, the elongate core having a length of less than or equal to about 10 mm and a diameter of less than or equal to about 100 μm; or
a combination thereof.

2. The electrochemical cell according to claim 1, wherein the Li₃PO₄-coated LLZO material is included as one or more of the following:
a coating on the separator;
a component of the separator;
a solid-state electrolyte particle disposed in the negative electrode; or
a solid-state electrolyte particle disposed in the positive electrode.

3. The electrochemical cell according to claim 1, wherein the separator is a solid-state electrolyte comprising the Li₃PO₄-coated LLZO material.

4. The electrochemical cell according to claim 1, wherein the separator is a polymeric separator comprising the Li₃PO₄-coated LLZO material as a coating disposed on the polymeric separator.

5. The electrochemical cell according to claim 4, wherein the polymeric separator comprises a polymer selected from the group consisting of polyacrylonitrile (PAN), polyvinylidene fluoride (PVDF), polyethylene (PE), polypropylene (PP), polyethylene terephthalate (PET), a polyamide, and combinations thereof.

6. The electrochemical cell according to claim 1, wherein the separator is a composite material comprising a polymeric matrix and the Li₃PO₄-coated LLZO material embedded within the polymeric matrix.

7. The electrochemical cell according to claim 1, wherein at least one of the positive electrode or the negative electrode comprises a solid-state electrolyte disposed therein, wherein the solid-state electrolyte comprises the Li₃PO₄-coated LLZO material.

8. The electrochemical cell according to claim 1, wherein the LLZO has a garnet crystal structure.

9. The electrochemical cell according to claim 1, wherein the LLZO is doped and has the formula Li_{7-3x-y}AlₓLa₃Zr_{2-y}M_{y}O₁₂, where M is Ta, Nb, or a combination thereof, 0≤x≤1, and 0≤y≤1; Li_{6.5}La₃Zr_{1.5}M_{0.5}O₁₂, where M is Nb, Ta, or a combination thereof; Li₇₋ₓLa₃Zr₂₋ₓBiₓO₁₂, where 0≤x≤1; Li_{6.2}Ga_{0.3}La_{2.95}Rb_{0.05}Zr₂O₁₂; Li_{6.65}Ga_{0.15}La₃Zr_{1.9}Sc_{0.1}O₁₂; or combinations thereof.

10. A lithium phosphate (Li₃PO₄)-coated lithium lanthanum zirconium oxide (LLZO) material comprising:
a core comprising the LLZO; and
a layer comprising the Li₃PO₄directly coating at least a portion of the core,
wherein the core is either a particle having a diameter of less than or equal to about 100 μm or a nanowire having a length of less than or equal to about 10 mm and a diameter of less than or equal to about 100 μm.

11. The Li₃PO₄-coated LLZO material according to claim 10, wherein substantially all of a surface of the core is coated with the layer comprising the Li₃PO₄.

12. The Li₃PO₄-coated LLZO material according to claim 10, wherein the LLZO has a garnet crystal structure.

13. The Li₃PO₄-coated LLZO material according to claim 10, wherein the core is the particle.

14. The Li₃PO₄-coated LLZO material according to claim 10, wherein the core is the nanowire.

15. The Li₃PO₄-coated LLZO material according to claim 10, wherein the Li₃PO₄-coated LLZO material is incorporated into at least one component of an electrochemical cell that cycles lithium ions, wherein the at least one component of the electrochemical cell is selected from the group consisting of a solid-state electrolyte, a separator, a coating on a separator, a positive electrode, a negative electrode, and combinations thereof.

16. A method of making a component of an electrochemical cell, the method comprising:
adding a lithium lanthanum zirconium oxide (LLZO) material to a phosphoric acid (H₃PO₄) solution to form a suspension, the LLZO material selected from the group consisting of a LLZO particle core having a diameter of less than or equal to about 100 a LLZO nanowire core having a length of less than or equal to about 10 mm and a diameter of less than or equal to about 100 and combinations thereof;
incubating the suspension until the suspension is substantially free of generating carbon dioxide (CO₂) to form a lithium phosphate (Li₃PO₄)-coated LLZO material; and
separating the Li₃PO₄-coated LLZO material from the suspension,
wherein the Li₃PO₄-coated LLZO material comprises a layer comprising the Li₃PO₄ directly coating at least a portion of the LLZO particle core, the LLZO nanowire core, or a combination thereof.

17. The method according to claim 16, wherein the Li₃PO₄-coated LLZO material is a powder comprising a plurality of the LLZO particle cores and the method further comprises:
optionally combining the powder with a sacrificial binder;
pressing the powder between a pair of platens; and
sintering the pressed powder to remove the sacrificial binder when present and to generate a solid-state electrolyte comprising the Li₃PO₄-coated LLZO.

18. The method according to claim 16, further comprising:
combining the Li₃PO₄-coated LLZO material with a polymer electrolyte, a surfactant, and a solvent to form a slurry;
casting the slurry on a substrate;
removing at least a portion of the solvent to form a composite film comprising the polymer electrolyte and the Li₃PO₄-coated LLZO material; and
removing the composite film from the substrate to yield an electrolyte film.

19. The method according to claim 16, wherein the Li₃PO₄-coated LLZO material is a powder comprising a plurality of the LLZO particle cores and the method further comprises:
combining the powder with a binder, a surfactant, and a solvent to form a slurry;
casting the slurry onto a surface of a polymeric separator; and
drying the slurry to form a film comprising the Li₃PO₄-coated LLZO on the surface of the polymeric separator.

20. The method according to claim 16, further comprising, prior to the adding:
casting a slurry comprising the LLZO material onto a surface of a polymeric separator; and
drying the slurry to form a film comprising the LLZO on the surface of the polymeric separator,
wherein the adding the LLZO to the H₃PO₄ solution comprises adding the polymeric separator having the film comprising the LLZO to the H₃PO₄ solution.
